(19) United States
(12) Patent Application Publication
(10) Pub. No.: US 2002/0001056 A1
(43) Pub. Date: Jan. 3, 2002

(54) Reflective microdisplay for light engine based video projection applictions

(76) Inventors: Edmund Sandberg, San Jose, CA (US); Arthur L. Berman, San Jose, CA (US); Gregory A. Prior, San Jose, CA (US); Paul J. Weihs, Fremont, CA (US)

Correspondence Address: Andrew V. Smith, Sierra Patent Group, P. O. Box 6149, Stateline, NV, 89449, US

(21) Appl. No.: 09/826,293

(22) Filed: Apr. 3, 2001

Related U.S. Application Data
(60) Provisional application No. 60/194,735, filed on Apr. 5, 2000.
(60) Provisional application No. 60/229,666, filed on Aug. 31, 2000.
(60) Provisional application No. 60/230,326, filed on Sep. 6, 2000.
(60) Provisional application No. 60/230,330, filed on Sep. 6, 2000.
(60) Provisional application No. 60/249,815, filed on Nov. 17, 2000.

(51) Int. Cl. G02F 1/1337

(52) U.S. Cl. 349/123

(57) ABSTRACT

A microdisplay includes a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate.

### PRIORITY

This application claims the benefit of priority to U.S. provisional patent applications No. 60/194,735, filed Apr. 5, 2000, 60/229,666, filed Aug. 31, 2000, 60/230,326, filed Sep. 6, 2000, 60/230,330, filed Sep. 6, 2000, and 60/249,815, filed Nov. 17, 2000.

### BACKGROUND OF THE INVENTION

1. Field of the Invention

The invention relates to a reflective microdisplay for light engine based video projection applications, and particularly to a liquid crystal on silicon (LCOS) rear projection microdisplay.

2. Discussion of the Related Art

A microdisplay can be defined as a flat-panel display technology in which the display has a diagonal of typically less than 3″. The microdisplay is a means for creating the imagery in a display system. Microdisplays have advantages over other display types in many applications because they are relatively inexpensive to manufacture, are physically small (leading to compact and less expensive optical systems), they can produce an image with very high resolution, aperture ratio, contrast ratio and brightness, and they consume a relatively low amount of power.

There are two broad classes of applications that can utilize microdisplays. The first are direct view applications. In this category, an image (possibly a virtual image) of the microdisplay is directly viewed through some sort of magnifying optics. Any portable system that requires a high-resolution display might utilize this technology. Examples of such systems are those produced by Inviso and Kopin. The second category are projection applications. In this category, an enlarged image of the microdisplay is projected onto and viewed on a screen.

There are two general configurations for projection and viewing. In the first configuration, the image is projected and viewed from the front of the screen. This is a front screen projector. In the second configuration, the image is projected onto the rear of the screen and viewed from the front. This is a rear screen projector. Two rear screen projection applications that currently use rear screen projection are HDTVs and computer monitors.

An optimum design of a microdisplay depends on the application for which it is intended. It is desired herein to provide a microdisplay optimized for specific rear screen projection applications. However, the present invention may be applied to microdisplays optimized for other applications including even those utilized in direct view systems.

There are many types of microdisplays suitable for projection applications. A first type is a scanned system. An example is a display system in which a microdisplay with a linear pixel array is used to modulate a transmitted or reflected light beam which is, in turn, electro-optically/mechanically scanned in an orthogonal direction. Such a system is, for example, produced by Reflection Technology. Other technologies use two-dimensional scanning.

A second type of microdisplay for a projection application is an emissive system, wherein pixels of the microdisplay emit light. Such a microdisplay is, for example, produced by Planar. Other emissive technologies under development for application to microdisplays include LEDs, OLEDs, vacuum florescent and FEDs.

A third type of microdisplay for a projection application is a transmissive systems, wherein light from an external source is modulated by transmission through the microdisplay. Such microdisplays are, for example, produced by Epson and Sony.

A fourth type of microdisplay for a projection application is a reflective system, wherein light from an external source is modulated by reflection off of the microdisplay. It is desired herein to provide a reflective microdisplay for a rear screen projection application. Such a reflective microdisplay will preferably be used in a physically compact and relatively inexpensive optical system, have a high resolution consistent with the reduced size, and will produce a desired on-screen brightness level.

Within the category of reflective microdisplays, there are two principle technologies. The first is Micro-Electrical-Mechanical-Systems (MEMS). In MEMS, an image is created by modulation of an external light source by reflection from a surface that contains moveable reflective or diffractive surfaces. Examples of this technology include micromirrors produced, e.g., by Texas Instruments, and addressable diffraction gratings, produced, e.g., by Silicon Light Machines. The second principle technology within the category of reflective microdisplays is Liquid-Crystal-On-Silicon (LCOS). LCOS systems are a variation on liquid crystal displays in which the back substrate is replaced by a silicon die upon which resides an actively addressed reflective pixel array. It is desired herein to provide a LCOS reflective microdisplay.

The desired LCOS microdisplay will allow production of a microdisplay with high resolution and a small display area. The desired LCOS display will allow the design of an optical system with a lower f# and higher light output. The desired LCOS display efficiently manages stray light, and produces an image with a high contrast ratio. The desired LCOS microdisplay is fabricated using materials and processes that are compatible with those currently used in existing commercial wafer and microdisplay foundries, and allows utilization of a wide range of qualified and interested foundries. In addition, the desired LCOS microdisplay allows production capacity at these foundries to be efficiently developed. The desired microdisplay allows for efficient manufacture and high yield during production ramp-up.

There are generally two types of LCOS microdisplays. The first are those that modulate by scattering. An example of this technology is the PDLC based microdisplay developed by National Semiconductor/Raychem Display Products Group. The second type of LCOS microdisplay are those that modulate polarization. Examples of this technology include microdisplays based on the ferroelectric effect (such as developed by DisplayTech and Micropix), the surface mode effect (such as developed by SpatiaLight and Ilixco), the OCB effect (such as reported by IBM), the diffractor effect (as reported by Kent State University) and various mixed mode effects (such as those developed by Three-Five Systems, S-Vision and Varitronix). It is further recognized herein that, in principle, a reflective microdisplay may be manufactured that modulates an image directly by the absorption of light. Such a device could, for example, utilize a nematic liquid crystal/pleochroic dye based on the electro-optic effect. It is desired herein to provide a LCOS reflective microdisplay that modulates polarization.

It is specifically desired to provide a LCOS reflective microdisplay that utilizes a mixed mode electro-optical effect. Such an LCOS microdisplay will advantageously produce shades of gray, and uses an efficient analog drive signal, as compared with other electro-optic effects that are inherently digital and which produce only a full white or a full dark state, and used an expensive, high speed, digital electronic driver. The desired LCOS microdisplay additionally utilizes a three channel optical system and allows the use of a slower electro-optic effect, compared with a one-channel color sequential system that uses a “faster” electro-optic effect. The desired microdisplay allows constant image changes, and may use an electro-optic effect wherein the image is continually refreshed in order to maintain a proper modulation state. An alternative electro-optic effect may use “storage” such that, once addressed, a pixel will stay white (or black) until addressed again. This alternative type of microdisplay may be used in a system in which the image changes relatively little and wherein it is desired to minimize power consumption. In view of the above, it is desired to provide a reflective LCOS microdisplay that uses a mixed mode electro-optical effect to modulate polarization.

The mechanical structure of the desired LCOS microdisplay preferably includes a pair of substrates joined together by an adhesive perimeter seal. The preferred bottom substrate is an active matrix silicon die and the top substrate is a cover glass. An electo-optics material such as liquid crystal preferably fills the “cell gap”. It is desired herein to provide a microdisplay having a precise and uniform cell gap. In view of this, it is further desired to provide sufficiently “flat” starting substrates. The desired microdisplay with sufficiently flat starting substrates advantageously allows deposition of various thin films onto the silicon to produce active matrix circuitry not tending to substantially distort the wafer.

Two variants exist in manufacturing processes currently in use to fabricate LCOS microdisplays. The primary difference between the two variants relates to the point during the fabrication process at which the substrates are divided into individual, microdisplay sized substrates. In the first process flow, the silicon wafer and the cover glass are divided into individual substrates early in the process. Individual substrates are processed and the microdisplays are fabricated one at a time. In the second process flow, intact silicon wafers and the cover glasses are processed and, at a later point in the flow, laminated together. Only at the end of the process are the laminates divided into individual microdisplays to complete processing. It is desired herein to provide means to “flatten” the silicon wafers that is applicable to both variants of the manufacturing process.

Liquid crystal materials respond to the RMS of an applied voltage. This response occurs regardless of whether the applied waveform is analog or digital. It is recognized herein that in LCOS microdisplay technology, the design of active matrix silicon backplanes may be based on two very different types of drive schemes: analog backplane and digital backplane.

With respect to analog backplane drive schemes, the amplitude of the voltage waveform is adjusted to vary the RMS voltage applied to the pixel. The analog backplane drive scheme typically requires a high voltage semiconductor process. This limits the number of semiconductor facilities that are available to fabricate the silicon backplane. In addition, a flicker-free frame rate will use a frequency of the analog signal that is very high, such as to push the state of the art in data transmission. The data transmission rate for the desired array size can also be very high, such that multiplexing the input signal to 2 or even 4 levels may be used. External electronics may be used to match the input impedance of the high voltage analog signal to that of the microdisplay.

With respect to digital backplane drive schemes, the applied voltage is either OFF or ON. The RMS of the voltage waveform applied to the pixel may be determined by the amount of time during the frame that the voltage is in the ON state. Sampling may be used in the process that converts the analog input signal to the digital pixel drive waveform. Precision in the timing of the sampling process may avoid the introduction of “transition” artifacts. The input capacitance of the digital backplane may be high because of the distributed loading within the active matrix array. This capacitance may not always be consistent and may be difficult to compensate. Errors can lead to artifacts such as ringing and overshoot. At the same time, it is recognized herein that the digital backplane offers the advantage of utilizing a low voltage semiconductor process, and less voltage is applied to the liquid crystal.

Both drive schemes typically use a fixed amplitude of the ITO voltage at half the maximum voltage that can be produced by the backplane. The amplitude of the backplane voltage then alternates above and below the ITO voltage. The purpose of the alternation is to time average the DC component of the waveform to zero. This prevents irreversible and destructive electrochemical changes in the liquid crystal material. Another consequence of this drive scheme is that the voltage applied to the liquid crystal is limited to a maximum of half that developed by the backplane. In some backplane designs, this limitation in amplitude can prevent the effective use of the range of otherwise desirable higher voltage liquid crystal electro-optic effects. In view of the above, it is desired herein to provide an improved digital backplane for use with a LCOS microdisplay.

It is desired to be able to effectively electrically probe the microdisplay to test for visual and electrical defects. Probe tips typically used to contact the silicon may, however, tend to scratch or otherwise damage the contact pads. This damage can eventually interfere with the ability to electrically connect the silicon to external electronics. The means of such connection for the desired microdisplay herein is either wire bonding or an Anisotropic Conductive Film (ACF). It is desired herein to provide means to modify the silicon so as to allow electrical probing of the microdisplay without interfering with the means to make external connection.

### SUMMARY OF THE INVENTION

In view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A non-rubbed alignment layer is disposed between the electo-optic material and at least one of the conducting layer of the covering substrate and the base substrate.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A non-rubbed alignment layer including a polymerizable polyimide is disposed between the electo-optic material and at least one of the conducting layer of the covering substrate and the semiconductor substrate.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. An alignment layer including an evaporated layer is disposed between the electo-optic material and at least one of the conducting layer of the covering substrate and the base substrate.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. An alignment layer including a grooved surface is disposed between the electo-optic material and at least one of the conducting layer of the covering substrate and the base substrate.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. One or more index-matching anti-reflection thin film coatings are formed on or under the conducting layer of the covering substrate for suppressing fringes on a displayed image.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. One or more index-matching anti-reflection thin film coatings are disposed between the covering substrate and the conducting layer thereon for suppressing fringes on a displayed image.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A perimeter seal encloses the electro-optic material between the covering substrate and the base substrate. A spacer array within the perimeter seal sets a gap spacing between the covering substrate and the base substrate.

Further in view of the above, a microdisplay is provided including a base substrate having an actively addressable pixel array thereon. Multiple electrical contacts connect the pixel array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A spacer array is disposed at spaces between pixels of the pixel array for setting a gap spacing between the covering substrate and the base substrate.

Further in view of the above, a microdisplay is provided including a base substrate having an actively addressable pixel array thereon. Multiple electrical contacts connect the pixel array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A spacer array is disposed at spaces between pixels of the pixel array for setting a gap spacing between the covering substrate and the base substrate, wherein one or more pixels of the pixel array are cropped to enlarge one or more spaces between pixels of the pixel array such that one or more of the spacers may be larger than an original size of the one or more cropped spaces.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A planarizing layer is disposed over the array of the base substrate.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A planarizing spin on layer is disposed over the array of the base substrate.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. The electro-optic material has a pi oriented surface mode configuration for permitting the microdisplay to utilize a fast electro-optical effect.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. The electro-optic material has a sigma surface mode configuration for permitting the microdisplay to utilize a fast electro-optical effect.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. The electro-optic material has a folded surface mode configuration for permitting the microdisplay to utilize a fast electro-optical effect.

Further in view of the above, a microdisplay is provided including a base substrate having an actively addressable pixel array thereon. Multiple electrical contacts connect the pixel array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. The electrical input circuit includes a digital backplane for applying discrete input values to pixels of the actively addressable pixel array multiple times per frame of generated images of the microdisplay. The voltages applied to the conducting layer of the covering substrate are selected in combination with the discrete input values applied to the pixels such that a voltage across the electro-optic material has a lower threshold value sufficient to maintain a retardation of not greater than λ/2.

Further in view of the above, a microdisplay is provided including a base substrate having an actively addressable pixel array thereon. Multiple electrical contacts connect the pixel array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. The external electrical input source includes a digital backplane for applying discrete input values to pixels of the actively addressable pixel array multiple times per frame of generated images of the microdisplay. The voltages applied to the conducting layer of the covering substrate are selected in combination with the discrete input values applied to the pixels such that the voltages are inverted an even number of times per frame to average a net applied DC voltage to approximately zero.

Further in view of the above, a microdisplay is provided including a base substrate having an actively addressable pixel array thereon. Multiple electrical contacts connect the pixel array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. The external electrical input source includes a digital backplane for applying discrete input values to pixels of the actively addressable pixel array multiple times per frame of generated images of the microdisplay. The voltages applied to the conducting layer of the covering substrate are selected in combination with the discrete input values applied to the pixels such that the voltages are inverted an even number of times per frame to average a net applied DC voltage to approximately zero. The electrical input circuit includes a storage node for storing inverted backplane voltages prior to application of the inverted voltages such that the stored voltages may be applied substantially simultaneously.

Further in view of the above, a microdisplay is provided including a base substrate having an actively addressable pixel array thereon. Multiple electrical contacts connect the pixel array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. The external electrical input source includes a low voltage digital backplane for applying discrete input values to pixels of the actively addressable pixel array multiple times per frame of generated images of the microdisplay. The electrical input circuit is formed on the base substrate.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A conductive trace is connected to an additional electrical contact on a same surface as the multiple electrical contacts. The additional electrical contact is connected to the opposing electrical terminal. A conductive crossover dot connects the conducting layer of the covering substrate to the conductive trace.

Further in view of the above, a microdisplay is provided including a stiffener and a base substrate coupled to the stiffener and having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate.

Further in view of the above, a microdisplay is provided including a stiffener and a base substrate coupled to the stiffener and having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A perimeter seal encloses the electro-optic material between the covering substrate and the base substrate. A spacer array within the perimeter seal sets a gap spacing between the covering substrate and the base substrate.

Further in view of the above, a microdisplay is provided including a stiffener and a base substrate coupled to the stiffener and having an actively addressable pixel array thereon. Multiple electrical contacts connect the pixel array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A spacer array is disposed at spaces between pixels of the pixel array for setting a gap spacing between the covering substrate and the base substrate.

Further in view of the above, a microdisplay is provided including a stiffener and a base substrate coupled to the stiffener and having an actively addressable pixel array thereon. Multiple electrical contacts connect the pixel array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A spacer array is disposed at spaces between pixels of the pixel array for setting a gap spacing between the covering substrate and the base substrate. One or more pixels of the pixel array are cropped to enlarge one or more spaces between pixels of the pixel array such that one or more of the spacers may be larger than an original size of the one or more cropped spaces.

Further in view of the above, a microdisplay is provided including a stiffener and a base substrate coupled to the stiffener and having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A planarizing layer is formed over the array of the base substrate.

Further in view of the above, a microdisplay is provided including a stiffener and a base substrate coupled to the stiffener and having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. A planarizing spin on layer is formed over the array of the base substrate.

Further in view of the above, a microdisplay is provided including a base substrate having an actively addressable array thereon. Multiple electrical contacts connect the array to an electrical input circuit. A covering substrate is disposed over the base substrate and has a conducting layer thereon. The conducting layer is electrically coupled to an opposing electrical terminal to the electrical input circuit. An electro-optic material is disposed between the conducting layer of the covering substrate and the base substrate. The multiple electrical contacts include multiple pad areas. At least some of the pad areas each include an area for making the contact with the electrical input circuit and an area for contacting a probe separate from the area for making the contact with the input circuit.

### BRIEF DESCRIPTION OF THE DRAWINGS

FIG. 1 schematically illustrates a side view of a reflective LOOS microdisplay.

FIG. 2A schematically illustrates a side view of a microdisplay illustrating external connections to the microdisplay.

FIG. 2B schematically illustrates a top view of the microdisplay of FIG. 2A.

FIG. 3 schematically illustrates a side view of a reflective LCOS microdisplay including an index-matched anti-reflection cover glass according to a preferred embodiment.

FIG. 4A schematically illustrates a perimeter seal of a microdisplay according to a preferred embodiment.

FIG. 4B schematically illustrates an exploded view of a portion of the perimeter seal of FIG. 4A.

FIG. 5A schematically illustrates a top view of an interpixel spacer array according to a preferred embodiment.

FIG. 5B schematically illustrates a side view of the interpixel spacer array of FIG. 5A.

FIG. 6A schematically illustrates a side view of a microdisplay with high speed electro-optic effects according to a first preferred embodiment.

FIG. 6B schematically illustrates a side view of a microdisplay with high speed electro-optic effects according to a second preferred embodiment.

FIG. 6C schematically illustrates a side view of a microdisplay with high speed electro-optic effects according to a third preferred embodiment.

FIGS. 7A-7B qualitatively illustrate drive timing for multi-level pulse width modulation for a microdisplay according to a preferred embodiment.

FIG. 8 schematically illustrates a circuit for producing the drive timing of FIGS. 7A-7B.

FIG. 9A schematically illustrates a side view of a microdisplay including a conductive cross-over dot according to a preferred embodiment.

FIG. 9B schematically illustrates a top view of the microdisplay of FIG. 9A.

FIG. 10A schematically illustrates a top view of a silicon wafer and stiffener.

FIG. 10B schematically illustrates a side view of the silicon wafer of FIG. 10A coupled to a ceramic stiffener according to a preferred embodiment.

FIGS. 11A-11B show alternative pad designs for a LCOS microdisplay according to preferred embodiments.

### INCORPORATION BY REFERENCE

What follows is a cite list of references each of which is, in addition to those references that may be cited above and below herein, and including that which is described as background of the invention, and the above invention summary, are hereby incorporated by reference into the detailed description of the preferred embodiment below, as disclosing alternative embodiments of elements or features of the preferred embodiments not otherwise set forth in detail below. A single one or a combination of two or more of these references may be consulted to obtain a variation of the preferred embodiments described in the detailed description below. Further patent, patent application and non-patent references may be cited in the written description and are also incorporated by reference into the detailed description of the preferred embodiment with the same effect as just described with respect to the following references:

U.S. patent application Ser. Nos. 60/192,258, 60/192,732, 60/198,436, 60/200,094, 60/202,265, 60/208,603, 60/210,784, 60/210,285, 60/213,334, 60/214,574, 60/215,932, 60/217,758, 60/220,979, 60/224,617, 60/224,961, 60/224,257, 60/224,503, 60/224,291, 60/224,290, 60/224,060, 60/224,059, 60/224,061, 60/224,289, 60/227,229, 60/230,330, 60/232,281, 60/234,415, 60/245,807, 60/198,486, 60/232,281, 60/245,807, and 60/249,815, each of which is assigned to the same assignee as the present application; and

Meyerhofer, Applied Phys. Lett., Vol. 29, No. 11, (December 1976);

D. Flanders, et al., Alignment of Liquid Crystals Using Submicrometer Periodicity, Appl. Phys. Lett., 32 (10), pp. 597-598 (May 15, 1978);

J. Janning, Thin Film Surface Orientation Crystals for Liquid Crystals, Appl. Phys. Lett., 21 (4), pp. 173-174 (Aug. 15, 1972); and

A. Mosley, et al., Surface Alignment of Liquid Crystals by Rubbed Polymer Layer Displays, pp. 17-21 (January 1987).

### DETAILED DESCRIPTION OF THE PREFERRED EMBODIMENTS

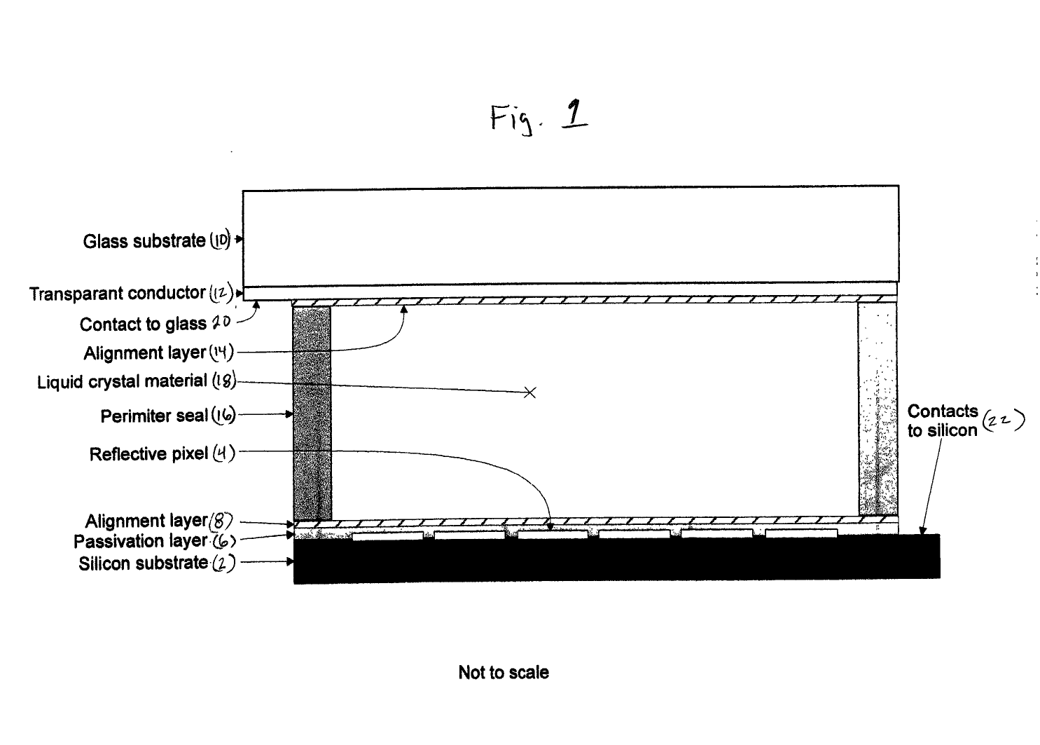

FIG. 1 schematically illustrates a side view of a reflective LCOS microdisplay according to one embodiment. The microdisplay shown in FIG. 1 includes a base silicon substrate 2. A reflective pixel array 4 is formed on the silicon substrate 2. A passivation layer 6 is shown in FIG. 1 and is preferably formed over the pixel array 4. An alignment layer 8 is shown formed over the passivation layer 6. A covering substrate 10 preferably formed of glass has a conducting layer 12 preferably formed of indium tin oxide (ITO) thereon. Another alignment layer 14 is shown formed over the conducting layer 12. The alignment layers 8 and 14 are preferred, and in some embodiments may be absent. A description of preferred configurations of the alignment layers 8 and 14 is described below, after a brief general description of the features of the micrdisplay of FIG. 1.

A perimeter seal 16 encloses an electro-optic material 18, which is preferably a liquid crystal material, together with the covering substrate 10 and base substrate 2. The base substrate 2 is shown staggered or offset in its alignment under the covering substrate 10. A ledge 20 of the covering substrate 10 that is non-overlapping of the base substrate 2 (shown facing downward at left in FIG. 1) provides a position for making contact to the transparent conducting layer 12 on the covering substrate 10. A ledge 22 of the base silicon substrate 2 that is non-overlapping of the covering substrate 10 (shown facing upward at right in FIG. 1) provides a position for making contact to the pixel array 4 on the silicon substrate 2.

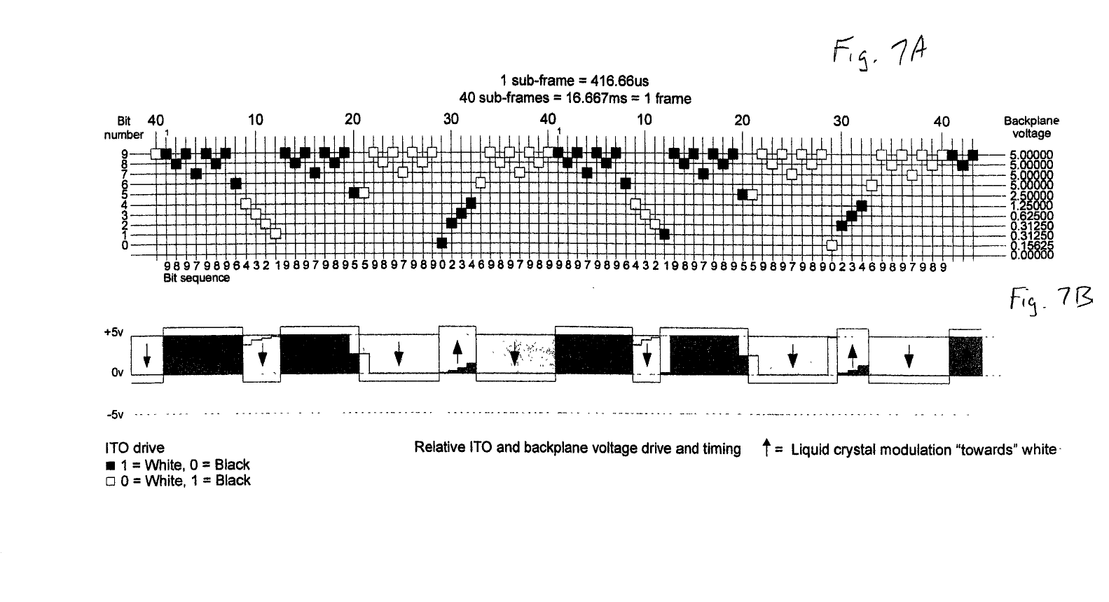

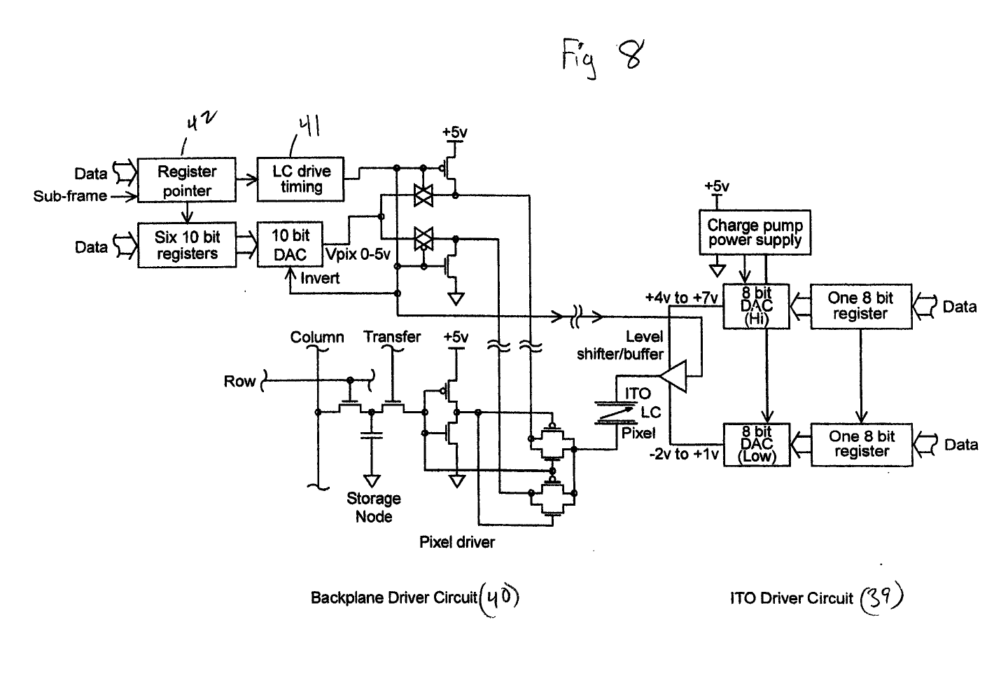

Although not shown, an electrical input circuit is connected preferably to contact pads at the silicon substrate ledge 22. An opposing terminal is connected to the ITO at the covering substrate ledge 20. The preferred circuitry and some description of the signals generated by the microdisplay circuitry are set forth below, and particularly with reference to FIGS. 7A-7B and 8.

Preferred and alternative features of the alignment layers 8 and 14 will now be described. In a first embodiment of a preferred alignment layer configuration, use of a UV/polymer method for non-rubbed alignment of the liquid crystal 18 is described below.

A Liquid Crystal Displays (LCDs) may be fabricated utilizing a uniaxially rubbed organic material as an alignment layer 8 and/or 14. Although this process is quite suitable for manufacturing LCDs, an alternative method is provided herein for LCOS. The reason is that the alternative process does not involve rubbing, and when rubbing is used, the surface of the silicon may be susceptible to physical damage, and the circuitry sensitive to damage from static electricity. An alignment method that does not require rubbing may therefore be advantageous for use with one or more embodiments herein.

The alternative method may utilize a photopolymerizable material, of which some polyimides are examples, as the alignment layer material. The unpolymerized material is coated onto the wafer by some means such as spin coating. The alignment is imposed by exposure of the unpolymerized material by collimated, polarized ultraviolet light. The direction of incidence of the UV light determines the subsequent liquid crystal alignment direction and the subsequent liquid crystal tilt angle. This method may be used for forming either or both of the alignment layers 8 and 14.

In a second alternative embodiment for the alignment layer configuration, use of an evaporated thin film for alignment of the liquid crystal 18 is described below. As mentioned, a rubbed polyimide (an organic polymer) alignment layer may be stable when subjected to the environmental conditions encountered in LCD applications. The use of a microdisplay in a video projector application may be an application wherein the second alternative embodiment may alternatively be used.

The light intensity to which the microdisplay and the alignment layer(s) 8 and/or 14 are exposed is relatively high in video projector applications compared with other applications. An alignment layer with high photostability is therefore advantageous and preferred herein.

A preferred alignment layer 8 and/or 14 is obtained by oblique evaporation of inorganic SiO. An advantageous liquid crystal tilt angle may be achieved by depositing a high angle evaporation on one substrate (zero tilt angle) and a low angle evaporation on the other (a tilt angle ˜25°). This results in an preferred average tilt angle of ˜12.5°. If a lower tilt angle is desired, then a double evaporation method can be used (see Meyerhofer, Applied Phys. Lett., Vol. 29, No. 11, December 1976, incorporated by reference above).

In a third alternative embodiment of an alignment layer configuration, use of a grooved surface for alignment of the liquid crystal is described below. As discussed above, an alignment layer with high photostability is advantageous for video projector applications, and may be used as an alternative approach to using a rubbed polyimide in one or more embodiments described herein. The third embodiment is advantageously achieved through the use of a grooved surface. Such surfaces understood by those skilled in the art for use with alignment of nematic liquid crystals may be used here. The alignment direction may be determined by controlling the direction of the grooves. The tilt angle may be controlled by the profile of the grooves as well as the groove material. The grooved surface may be formed onto the surface of the silicon and onto the cover glass by such methods as photolithography and/or embossing.

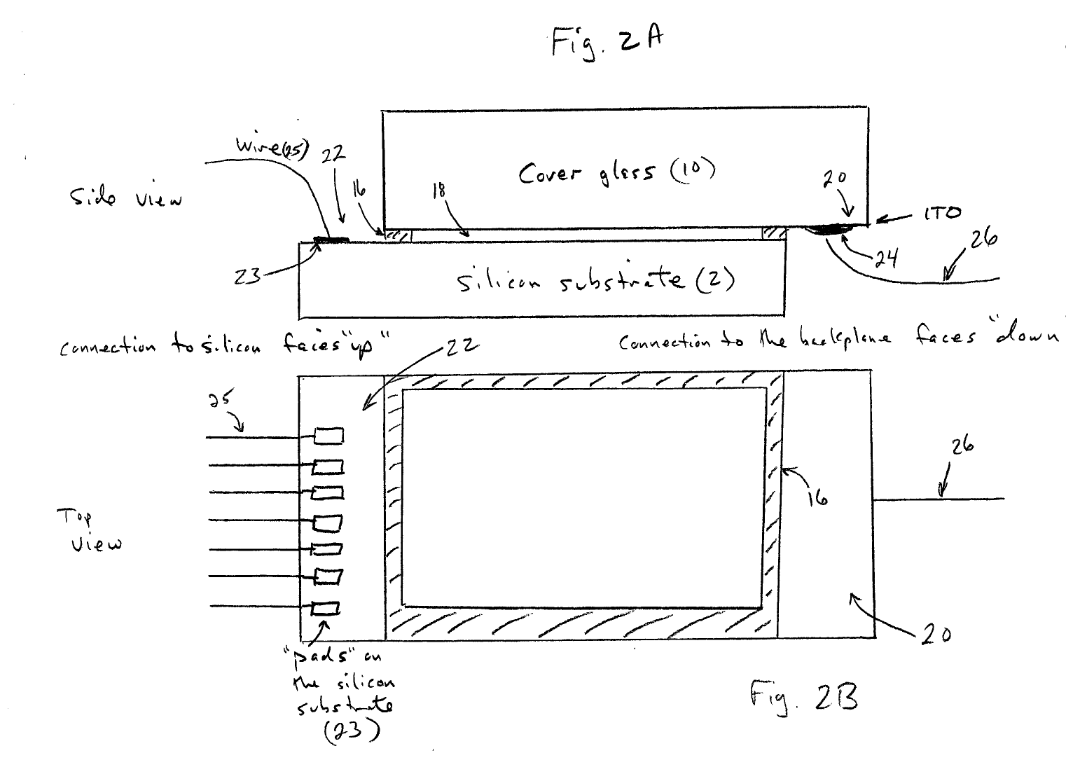

FIG. 2A-2B schematically illustrate a side view and a top view, respectively, of a microdisplay similar to or the same as that shown and described with respect to FIG. 1, further illustrating electrical connections to the microdisplay. FIGS. 2A and 2B may or may not have one or both alignment layers 8 and 14, as described above, and may include other features of these preferred embodiments set forth below.

FIG. 2A shows the silicon substrate 2, the covering substrate 10 and perimeter seal 16 enclosing the electro-optic material 18. The contact ledge 20 of the covering substrate 10 and the contact ledge 22 of the silicon substrate 2 are also shown. A contact pad 23 (and preferably several, see FIG. 2B) is shown formed on the ledge 22 of the silicon substrate 2. A conducting wire 25 is shown extending from the contact pad 23 and connects to electrical input circuitry for the microdisplay. A contact 24 is shown formed on the ITO of the ledge 20 where a contact is made and conducting wire 26 is shown connecting the ITO to an opposing terminal to the electrical circuitry connected to the wire 25 and wire pad 23.

FIG. 2B schematically illustrates a top view of the microdisplay of FIG. 2A. The top view of FIG. 2B shows that several pads 23 connect several wires 25 and electrical input circuitry to the microdisplay preferably on the silicon substrate 2.

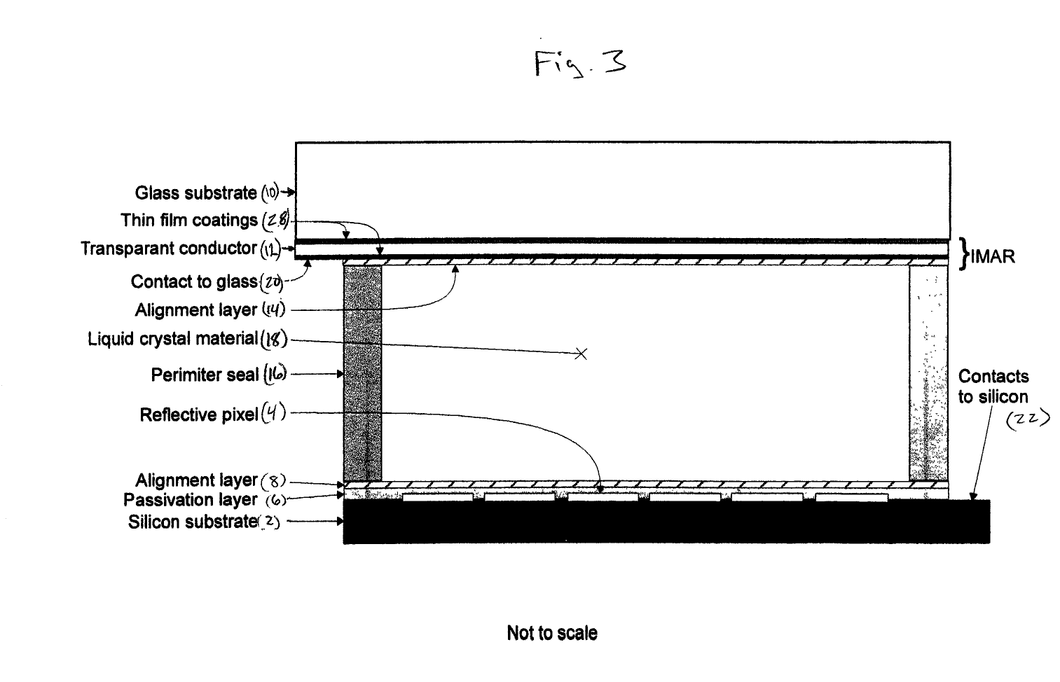

FIG. 3 schematically illustrates a side view of a reflective LCOS microdisplay according to a preferred embodiment. The microdisplay of FIG. 3 includes the silicon substrate 2 with reflective pixels 4 thereon, passivation layer 6, perimeter seal 16, electro-optic material 18, preferred alignment layers 8 and 14 (see above), covering substrate 10 having transparent conductor layer 12 thereon, and ledges 20 and 22 for making contact between the conductor layer 12 and electrical input circuitry and contacts pads 23 (see FIG. 2B) and opposing electrical circuitry, respectively. The microdisplay of FIG. 3 further advantageously includes preferably multiple thin film coatings 28 for providing an index-matched anti-reflection cover glass structure.

The Index Matched Anti-Reflection (IMAR) cover glass, including SiO₂ and possibly other materials as understood by those skilled in the art, is provided to suppress fringes. One challenge in fabricating LCOS is to produce a uniform spacing (gap) between the upper surface of the silicon and the lower surface of the cover glass. If the manufacturing process is not able to produce microdisplays with a uniform gap then there may be several problems including fringes.

Fringes are dark bands superimposed on the image displayed by the microdisplay when it is illuminated with polarized light having a narrow spectral bandwidth (as it preferably does in each channel of the projector). The fringes are caused by interference between light rays that have differing path lengths (due to the non-uniform gap) as they travel back and forth through the gap. The reason that there are light rays making multiple trips through the gap is that there is a slight reflection at the interface between the liquid crystal and the cover glass. The reflection originates from the small index of refraction mismatch between the liquid crystal 18 and transparent conductive coating 12 (Indium Tin Oxide or ITO) on the surface of the cover glass 10 and between the ITO 12 and the glass 10 itself. The alignment layer 14 is typically so thin as to have little effect on the reflectivity of the surface. Fringes are highly objectionable and the visibility of these fringes is advantageously suppressed according to this preferred embodiment, as illustrated at FIG. 3.

The thin film coatings 28 are formed within the covering substrate structure, preferably as illustrated at FIG. 3. The coatings 28 are shown disposed both under and above the ITO 12. Alternatively, the coatings 28 may be placed only under or only on top of the ITO 12. The coatings 28 serve to “index match” the substrate 10 to the liquid crystal 18. These IMAR coatings 28 reduce the residual reflectivity mentioned above and suppress the visibility of the fringes.

Even if fringes have been rendered invisible owing to the use of the IMAR coatings 28 described above with reference to FIG. 3, a uniform gap between the covering substrate 10 (and conducting layer 12 and any other layers such as layer 14, e.g.) and the silicon base substrate 2 is still very much desired. Variations in the gap result can result in variations in the strength of the electric field applied across the liquid crystal layer 18. This, e.g., can produce variations in a shade of gray when it is intended that the microdisplay display a uniform shade of gray.

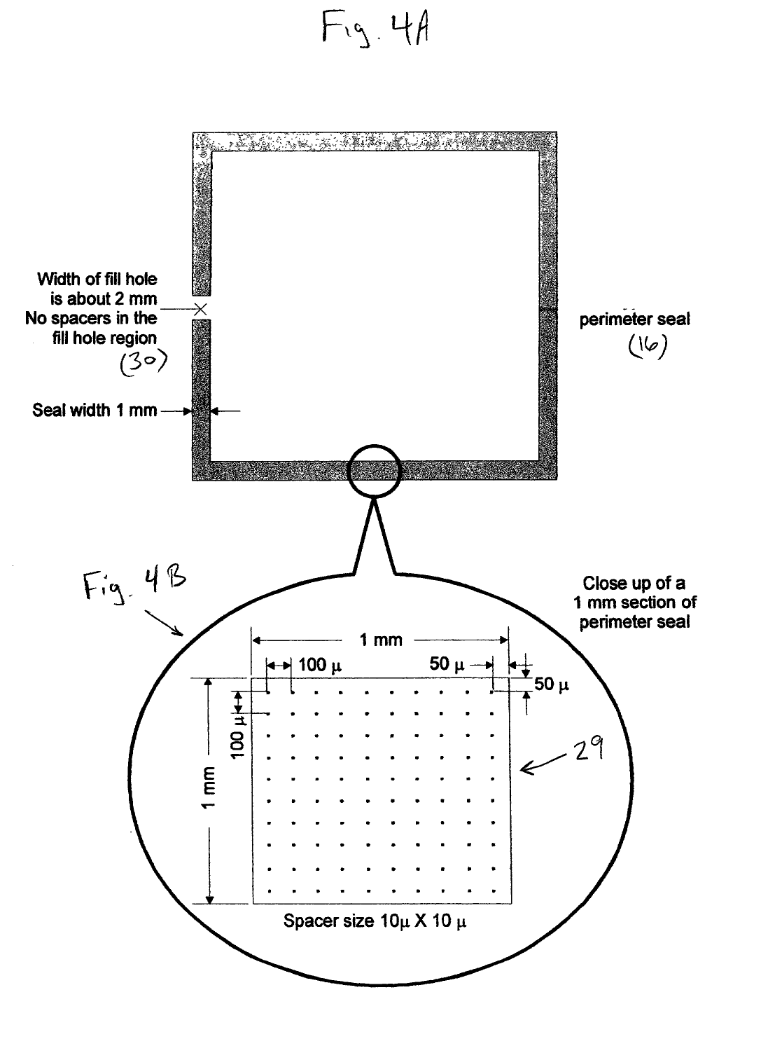

The gap spacing is advantageously controlled according to the microdisplay of the embodiment illustrated at FIGS. 4A-4B. Control, in this case, means both obtaining a correct nominal gap spacing as well as accomplishing a desired uniformity. Gap control is provided through the use of a spacer array 29 located within the perimeter seal 16.

FIG. 4A illustrates a perimeter seal 16 having a spacer array formed therein. In this embodiment, a fill region 30 is shown for filling the liquid crystal 18 (see FIG. 3) into the gap. There are preferably no spacers in this fill region 30. Preferred spacers of the spacer array 29 may be formed from a thin film or a polymer material. Consistent with these materials, the aspect ratio of the spacers is further provided such that they are physically strong.

FIG. 4B schematically illustrates an exploded view of a 1 mm portion of the perimeter seal 16 of FIG. 4A. The spacers shown are 10 μm×10 μm in geometric extent and are uniformly spaced at about 100 μm intervals in two dimensions. The spacers at the boundaries are shown to be about 50 μm from the edge of the perimeter seal 16.

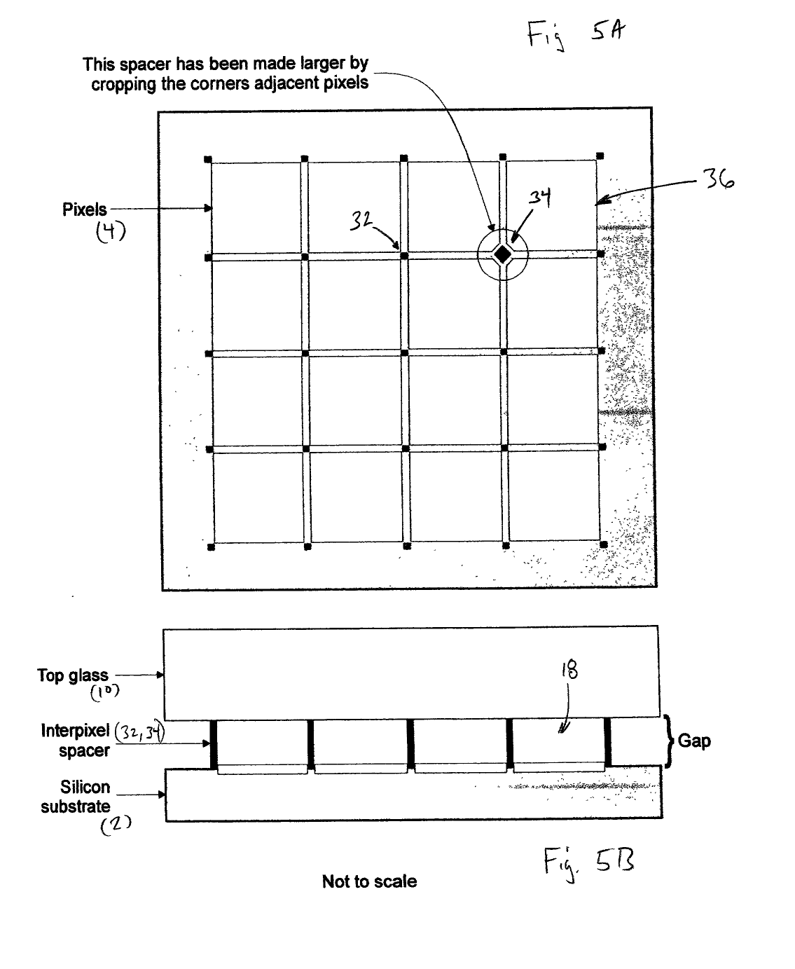

Gap control may further be achieved through the use of an array of Interpixel spacers 32 and/or 34, as shown in FIG. 5A, which schematically illustrates a top view of an interpixel spacer array according to a preferred embodiment. The spacers 32 are located at corners of four typical pixels 4. Any spacers 34 can be located at corners including one or more cropped pixels 36. The strength of the spacers 32 and/or 34 are such that the spacers 32, 34 effectively control the gap spacing. The material from which the spacers 32, 34 are made and their width/height ratios are carefully selected. A typical gap spacing between the substrates 2 and 10 may range from about 1 to 5 μm (depending on a variety of factors including the electro-optic effect), while the interpixel spacing might fall in the range of from 0.5 to 1.5 μm. In order to strengthen the spacer array, the diameters of spacers 34 can be larger than spacers 32, i.e., by allowing the spacers 34 to slightly intrude into corners of the pixels 36. Due to their small size, the spacers 32, 34 will not be visible to the human eye, and will not affect the images produced by the microdisplay. Note that in creating the interpixel spacers 32, 34, the means of formation is configured consistent with the an interpixel fill. FIG. 5B schematically illustrates a side view of the interpixel spacer array of FIG. 5A.

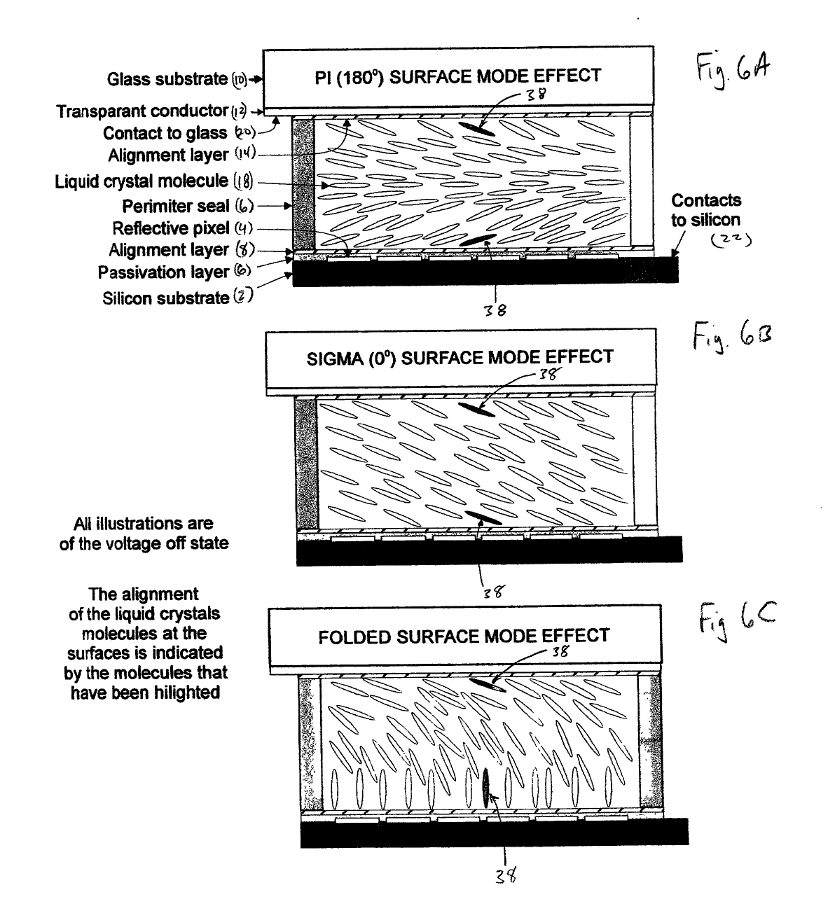

A further feature according to a preferred embodiment is illustrated at FIGS. 6A-6C, relating to use of a high-speed electro-optic effect in a LCOS microdisplay. A fast switching microdisplay is desired for use with color sequential applications and applications in which shades of gray are accomplished by black/white dithering. A feature of the high LCOS microdisplay embodiments illustrated at FIGS. 6A-6C is that the microdisplay utilizes a fast electro-optical effect. Three different LCOS microdisplays designed with fast electro-optic effects are illustrated at FIGS. 6A-6C. Referring to FIG. 6A, the alignment of the liquid crystal molecules are according to a pi (or 180°) oriented surface mode configuration. At FIG. 6B, the alignment of the liquid crystal molecules are according to a sigma (or 0°) oriented surface mode configuration. At FIG. 6C, the alignment of the liquid crystal molecules are according to a folded surface mode liquid crystal configuration. Each of the configurations illustrated at FIGS. 6A-6C have the advantage of being suitable for manufacture at existing liquid crystal microdisplay foundries. The configurations of FIGS. 6A-6C may be formed using techniques such as spin coating, thermal or electron beam evaporation, LD- or HD-CVD, or another process as understood by those skilled in the art.

Further in accord with a preferred embodiment, FIGS. 7A-7B qualitatively illustrate drive timing for multi-level pulse width modulation for a microdisplay. Each frame is preferably divided into 60 frames. As shown at FIG. 7A and in the table below, each frame is further divided into 40 sub-frames. During each interval, a “digital” voltage is applied. In this usage, digital refers to the fact that the applied voltage takes on one of several discrete values. By applying these digital voltages in various combinations during the intervals, it is possible to develop 1024 different voltage values during the frame.

The scheme is particularly illustrated with reference to the table below.

| | | | Voltage Value is a | |
|---|---|---|---|---|
| | | | product of these two colums | |
| | | | | Number of |
| | | Voltage | | Sub-frames |
| | | Value | Voltage | During frame |
| | Binary | assigned | Assigned | assigned |
| | Value of the | to the | to the | to the |
| Bit Number | Bit Number | Binary Value | Bit Number | Bit Number |
| 0 | 2 | 0.15625 | 0.15625 | 1 |
| 1 | 4 | 0.31250 | 0.31250 | 1 |
| 2 | 8 | 0.62500 | 0.31250 | 2 |
| 3 | 16 | 1.25000 | 0.62500 | 2 |
| 4 | 32 | 2.50000 | 1.25000 | 2 |
| 5 | 64 | 5.00000 | 2.50000 | 2 |
| 6 | 128 | 10.00000 | 5.00000 | 2 |
| 7 | 256 | 20.00000 | 5.00000 | 4 |
| 8 | 512 | 40.00000 | 5.00000 | 8 |
| 9 | 1024 | 80.00000 | 5.00000 | 16 |

The 1024 voltage levels correspond with values that can be produced by a 10-bit binary number. Recall that in binary counting, each succeeding bit in the number has a value that is twice that of its predecessor. In the drive scheme illustrated in the table and at FIG. 7A, each successive bit in the 10-bit number is assigned a voltage that is twice as large as the preceding bit. As shown, 5V is selected as the largest voltage because this value is typical of the maximum that can be developed by a backplane produced by a “low voltage” semiconductor fabrication process. As indicated in the table, production of some voltage values occurs due to a given voltage being applied multiple times during the frame. The intervals during which these given voltages are applied may or may not be sequential. In fact, it is preferred that all multiple intervals be “spread out uniformly” during the frame. As shown at FIG. 7A, this is indicated as the “bit sequence”. This is done to minimize voltage variations during the sub-frame.

Some examples of these “binary” voltage levels are as follows: voltage level 0 (the smallest) is obtained by applying 0V during 40 sub-frames; voltage level 1 is obtained by applying 0.15625V for one interval and 0V during 39 sub-frames; voltage level 2 is obtained by applying 0.31250V for one interval and 0V during 39 sub-frames; voltage level 3 is obtained by applying 0.31250V for one interval, 0.15625V for one sub-frame, and 0V during 38 sub-frames; voltage level 4 is obtained by applying 0.62500V for 1 sub-frame and 0V during 39 sub-frames; voltage level 5 is obtained by applying 0.62500V for one sub-frame, 0.15625V for 1 sub-frame and 0V during 38 sub-frames; voltage level 661 is obtained by applying 5.00000V for 20 sub-frames, 2.50000V for 1 sub-frame, 0.62500 for 1 sub-frame, 0.15625 for 1 sub-frame and 0V during 17 sub-frames; and voltage level 1023 (the largest) is obtained by applying 5.0000V for 30 sub-frames, 2.50000V for 2 sub-frames, 1.25000V for 2 sub-frames, 0.62500V for 2 sub-frames, 0.31250V for 3 sub-frames, and 0.15625V for 1 sub-frame.

The details of the waveform applied to the pixels 4, 34 is next described. As illustrated at FIG. 7A, the voltage on the ITO (V_{ITO}) varies between a value that is just below ground to a value that is somewhat above the maximum +5 volts that can be developed by the silicon backplane (V_{BP}). Recall that the voltage on the liquid crystal V_{LC}=V_{ITO}−V_{BP}. The indicated values of V_{ITO} were selected so that there would always be at least a small V_{LC}. More specifically, the values for V_{ITO} are preferably selected so that V_{LC} will always be enough to produce a retardation that is not greater than λ/2, where λ/2 is the retardation that produces the brightest possible white state. Since this corresponds to the maximum retardation that is used, any lower voltage values are also not used.

Another feature of the waveform is that the ITO 12 and the backplane voltages (applied to the pixels 3, 34) are inverted an even number of at least two and preferably several times during each frame. In the example illustrated at FIG. 7A, there are six inversions per sub-frame. The inversions are indicated by changes from white to black or black to white in FIG. 7A. The inversions do not change the RMS of V_{LC}. Consequently, the shades of gray produced by the pixels 4, 34 are not effected by the inversion. The inversions do, however, advantageously serve to average any net DC to approximately zero during the course of the frame.

Three further points regarding the polarity inversion are the following. First, since the polarity of the voltage is inverted, in the example, 240 times each frame (6 times per sub frame with 40 sub-frames per frame), any flicker that may exist will be substantially or entirely invisible.

Second, the smallest bit number (the 0 bit in the bit sequence illustrated in FIG. 7A), which is the bit with an assigned voltage of 0.15625V (see “Bit number” 0 on the abscissa and “Bit sequence” position 0 on the ordinate), appears only once during the sub-frame and is, therefore, not DC “balanced” within the frame. That is, both a positive and a negative voltage for this bit do not appear within each frame. Rather, DC balance of this “least significant” 0 bit is accomplished by alternating its polarity from frame to frame. This too is indicated in FIG. 7A. The consequent 30 Hertz voltage variation that may occur and that is associated with this bit, would produce a flicker effect that is far too small to produce a substantial visible effect.

Third, when the polarity of the voltages applied during the frame are inverted, it is desired that not only the V_{ITO} but all of the V_{BP} change substantially simultaneously. Inverting the V_{ITO} is trivial. To simultaneously change all of the V_{BP}, however, in a preferred embodiment, a “storage node” is included as part of the electrical input circuitry located at each pixel 4, 34. While one polarity is being displayed, the voltages for the other polarity are written into the storage node. The voltages in the storage node are applied to all of the pixels 4, 34 simultaneously when an appropriate signal is applied to the “Transfer” line of the electrical input circuitry.

A further feature of the semiconductor fabrication process used to produce the “low voltage” digital backplane is that it allows the integration of the low voltage multiplex communication input/output circuitry, such as LVDS or TMDS circuitry, directly onto the same silicon 2 as the backplane. Such integration advantageously eliminates the expense of external circuitry to perform this function.

FIG. 7B qualitatively illustrates the polarities and voltages applied according to the exemplary drive scheme shown at FIG. 7A. The design of a circuit that can generate the waveforms for implementing the driving scheme discussed above is illustrated at FIG. 8. Note that the driver 39 for the ITO and the driver 40 for the backplane can be physically separate circuits. Synchronization of the waveforms produced by these two circuits is accomplished by circuitry in the block labeled “LC drive timing” 40. The function of the block labeled “Register pointer” 42 is to “uniformly distribute” the voltage associated with a given bit to the various sub-frames allotted to it within the frame.

The backplane and drive scheme described above have many advantages including that a low voltage semiconductor process can be utilized to fabricate the backplane. Such a process is available at a wide range of semiconductor fabs. Due to the availability of the synchronized voltage swing on the ITO 12, a “high” voltage can be applied to the pixels 4, 34 compared with conventional systems, as mentioned above in the background. This allows utilization of higher voltage liquid crystal electro-optical effects. Due to the fact that the polarity is inverted 6 times per 40 sub-frames during each of the 60 frames/sec, flicker is substantially if not entirely eliminated. In addition, the voltage is periodically inverted in such a way as to accurately balance the DC component to zero. Moreover, the digital data transfer rate used in the preferred drive scheme is well within the current state of the art. Further, with LVDS or TMDS circuitry integrated onto the backplane, this approach eliminates the expense of external circuitry. Also, since the backplane is digital, the expense of AD and DA circuitry is eliminated. Also, since the pixel drive waveform is digital, there will not be any artifacts related to the analog input signal.

A general description and illustration of a LCOS microdisplay have been described above and particularly at FIGS. 2A-2B. Referring briefly back to FIGS. 2A-2B, it is noted here that electrical connection to the top or covering substrate 10 is made by contacting the ITO 12 on the bottom surface of the ledge 20 formed by the extension of the cover glass 10, or staggered alignment of the cover glass 10 with the silicon substrate 2. Electrical connections to the base or silicon substrate 2 are made to pads 23 on the top surface of the ledge 22 formed by the extension of the silicon 2. Such a configuration makes electrical connection to an external circuit somewhat difficult since contact is made at two locations, and one set of contacts faces “up” while the other set faces “down”.

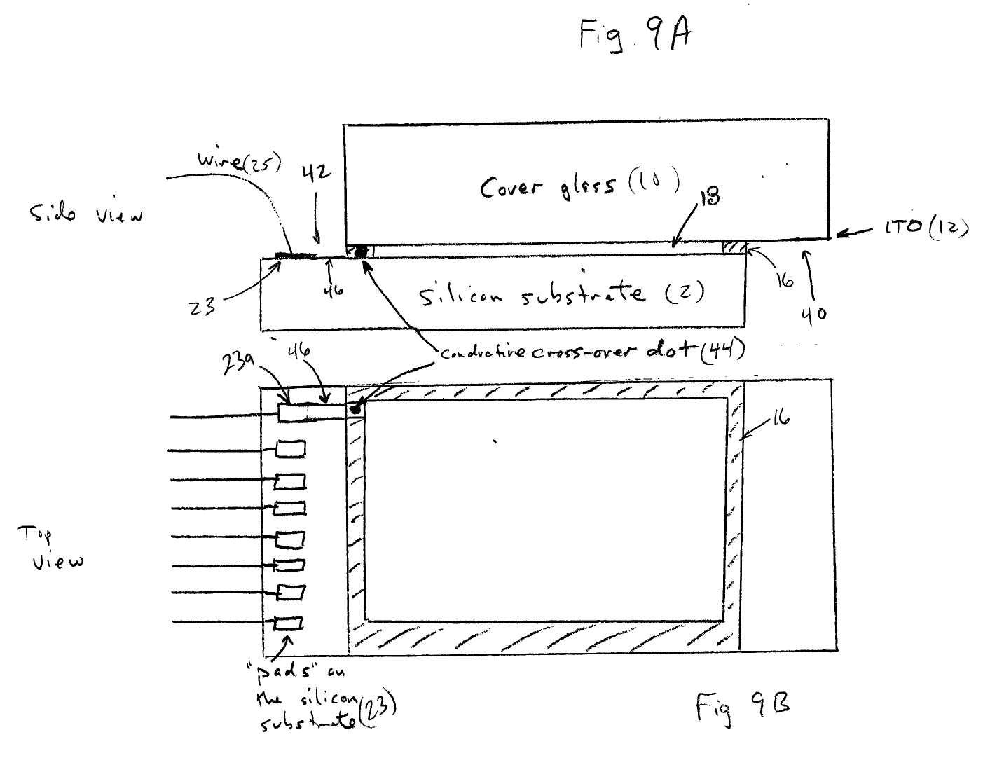

FIG. 9A illustrates a side view of an advantageous microdisplay according to a preferred embodiment wherein the electrical connections are each made on one ledge 42, corresponding to ledge 22 of FIG. 2A, and from a single direction, i.e., the connections to the pixels 4, 34 of the reflective pixel array and the conductive layer 12. In particular, FIG. 9A schematically illustrates a side view of a microdisplay including a conductive cross-over dot 44 according to a preferred embodiment. FIG. 9B schematically illustrates a top view of the microdisplay of FIG. 9A.

The crossover dot 44 is used with the LCOS microdisplay of a preferred embodiment. The configuration shown at FIGS. 9A-9B include the ledge 40, corresponding to the contact ledge 20 of the cover glass 10 of FIG. 2A, wherein the contact 24 on the ledge 20 has been eliminated from the ledge 40 of FIG. 9A. A conductive crossover dot 44 has been inserted between the substrates 2 and 10. The crossover dot 44 is located, in this example, in and through the perimeter seal 16. The crossover dot 44 serves to short between the ITO 12 on the cover glass 10 and an extra conductive trace 46 on the silicon substrate 2. This extra trace 46 is brought to a pad 23a on the silicon ledge 42. In this way, the contact to the ITO 12 is made, along with all of the silicon contacts 23 to the pixels 4, 34 on the silicon ledge 42 and from one direction.

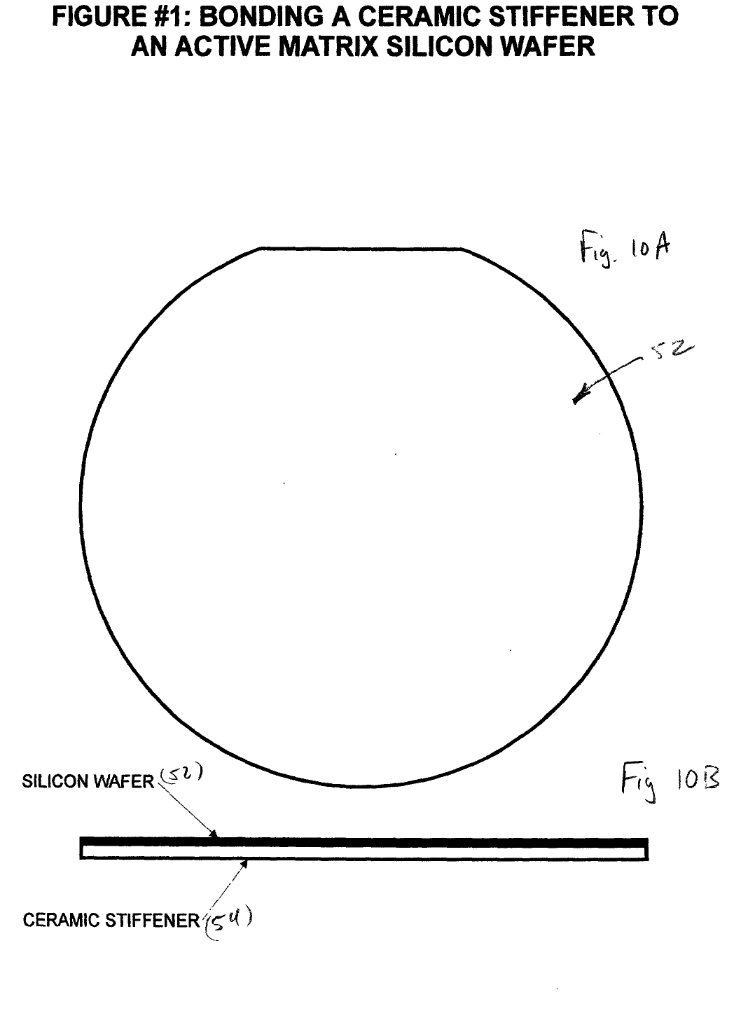

FIG. 10A schematically illustrates a top view of a silicon wafer 52, e.g., which may provide the base substrate 2 of a preferred embodiment. FIG. 10B schematically illustrates a side view of the silicon wafer 52 of FIG. 10A coupled to a ceramic stiffener 54 according to a preferred embodiment. As illustrated in FIG. 10B, the wafer 52 is laminated to the stiffener 54 such that the wafer 52 is laminated to a very flat, very stiff backing plate. The stiffener is preferably a ceramic, such as alumina ceramic. During the lamination process, the wafer 52 may be pressed down onto the stiffener 54 so as to flatten the wafer 52, and an adhesive (not shown) is provided between the wafer 52 and the stiffener 54. Once the wafer 52 is properly flattened and in position, the adhesive is then cured. The adhesive chosen for this application preferably shrinks very little on cure, and also has a temperature coefficient well matched to silicon. A preferred class of adhesives appropriate for this application are thereby those that cure with UV light, or a UV adhesive. The cure is then preferably accomplished by the transmission of UV light through the ceramic 54, and so, the ceramic 54 is preferably transmissive to the UV light. Alumina nitride is the preferred material of the stiffener 54.

The wafer/backing plate 2 would then be processed through the microdisplay manufacturing process using procedures, e.g., as set forth herein. Regardless of which process variant is used, the lamination will eventually be diced into individual microdisplay sized components. A preferred means is to saw through the ceramic 54 and partially into the silicon 52. The substrate 52 is then “broken” into individual substrates 2.

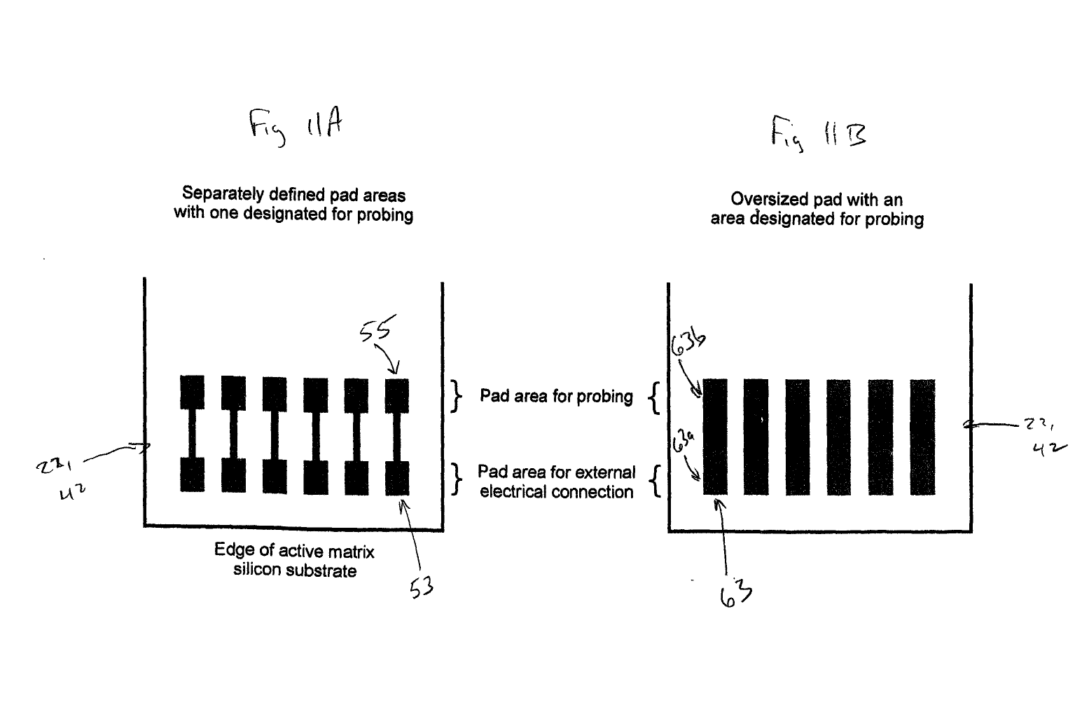

FIGS. 11A-11B show alternative pad designs for a LCOS microdisplay according to preferred embodiments. FIG. 11A shows the silicon ledge 22, 42 of earlier embodiments such as those shown at FIGS. 2A and 9A. The ledge 22, 42 has a set of contact pads 53 corresponding to pads 23 of FIG. 2A for contacting wires 25 for connection to electrical input circuitry. The ledge also has an additional set of contact pads 55 that are electrically connected to the pads 53. The contact pads 55 are used for allowing a probe to make contact for diagnosis without disturbing the pads 53.

FIG. 11B shows a set of contact pads 63 that correspond to the contact pads 23 of FIG. 2A, but the pads 63 are enlarged compared with the pads 23. The pads 63 includes a contact area 63a which is used for contacting the electrical input circuitry of the microdisplay, and a contact area 63b that is used for a probe to contact the pads 63, wherein the probe contact to area 63b does not disturb the area 63a, which is reserved for contacting the electrical input circuitry.

Common to both embodiments shown at FIGS. 11A and 11B, is that the original pad areas 53 and 63A, of FIGS. 11A and 11B, respectively, are left untouched by contact to a probing device and reserved solely for connection to the electrical input circuit of the microdisplay. Each embodiment includes an additional pad area 55, 63b exclusively for probing. As illustrated in FIGS. 11A and 11B, the additional pad area can take several forms. At FIG. 11A, a separately defined area 55 is designated exclusively for probing. At FIG. 11B, a single oversized pad area 63 has the area 63b designated as exclusive for probing.

An improved planarization layer may be used with any of the above embodiments according to a preferred embodiment. One or more alignment layers 8, 14 are used as described above to align the molecules of the liquid crystal 18 in the preferred LCOS microdisplay. The surface underlying the alignment layer 8, 14 is preferably substantially physically flat. However, the surface of an active matrix array has considerable structure and is not generally physically flat. A planarization layer is provided over the array to make the surface more planer. According to a preferred embodiment, the planarization layer is a spin on layer of Cyclotene. This family of Dow Chemical Company materials has many desirable properties for use in this preferred embodiment. Cyclotene can be spun on easily and is self leveling even in thin layers. In addition, Cyclotene does not interfere with the function of the alignment layer or otherwise deleteriously effect the lifetime of the liquid crystal 18. It is noted that some Cyclotene materials are capable of being patterned, and thus, in principle, Cyclotene can be used as the material for the spacer elements of FIG. 4B or the spacers 32, 34 of FIGS. 5A and 5B. In an alternative embodiment, a spin on glass is used as the planarization material.

The preferred microdisplay is subject to numerous adaptations from those described herein as would be understood to those skilled in the art. For example, the microdisplay may be made in various aspect ratios including 4:3, 5:4, 16:9, and 16:10, among others. The uppermost surface of the covering substrate 10 can have an anti-reflection coating formed thereon if desirable depending on other aspects of the optical system. The length of the covering glass ledge 20, 42 and the silicon contact ledge 22, 40 can be changed to meet packaging requirements. The thickness of the covering glass 10 can be changed to meet microdisplay fabrication requirements.

Therefore, while exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and equivalents thereof.

What is claimed is:

1. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
a non-rubbed alignment layer between the electo-optic material and at least one of the conducting layer of the covering substrate and the base substrate.

2. The microdisplay of claim 1, wherein the alignment layer comprises a spin on coating.

3. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
a non-rubbed alignment layer comprising a photopolymerizable polyimide between the electo-optic material and at least one of the conducting layer of the covering substrate and the semiconductor substrate.

4. The microdisplay of claim 3, wherein the alignment layer comprises a spin on coating.

5. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
an alignment layer comprising an evaporated layer between the electo-optic material and at least one of the conducting layer of the covering substrate and the base substrate.

6. The microdisplay of claim 5, wherein said alignment layer is an obliquely evaporated layer of SiO.

7. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
an alignment layer comprising a grooved surface between the electo-optic material and at least one of the conducting layer of the covering substrate and the base substrate.

8. The microdisplay of claim 7, wherein said grooved surface is a diffraction grating.

9. The microdisplay of claim 7, wherein said grooved surface is a photolithographically etched surface.

10. The microdisplay of claim 7, wherein said grooved surface is an embossed surface.

11. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
one or more index-matching anti-reflection thin film coatings between the covering substrate and the base substrate for suppressing fringes on a displayed image.

12. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
one or more index-matching anti-reflection thin film coatings between the covering substrate and the conducting layer thereon for suppressing fringes on a displayed image.

13. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate;
a perimeter seal for enclosing the electro-optic material between the covering substrate and the base substrate; and
a spacer array within the perimeter seal for setting a gap spacing between the covering substrate and the base substrate.

14. The microdisplay of claim 13, wherein the spacers comprise a thin film material.

15. The microdisplay of claim 13, wherein the spacers comprise a polymer material.

16. A microdisplay, comprising:
a base substrate having an actively addressable pixel array thereon;
a plurality of electrical contacts for connecting the pixel array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
a spacer array disposed at spaces between pixels of the pixel array for setting a gap spacing between the covering substrate and the base substrate.

17. The microdisplay of claim 16, wherein the spacers comprise a thin film material.

18. The microdisplay of claim 16, wherein the spacers comprise a polymer material.

19. A microdisplay, comprising:
a base substrate having an actively addressable pixel array thereon;
a plurality of electrical contacts for connecting the pixel array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
a spacer array disposed at spaces between pixels of the pixel array for setting a gap spacing between the covering substrate and the base substrate, wherein one or more pixels of the pixel array are cropped to enlarge one or more spaces between pixels of the pixel array such that one or more of said spacers may be larger than an original size of the one or more cropped spaces.

20. The microdisplay of claim 19, wherein the spacers comprise a thin film material.

21. The microdisplay of claim 19, wherein the spacers comprise a polymer material.

22. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
a planarizing layer over the array of the base substrate.

23. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
a planarizing spin on layer over the array of the base substrate.

24. The microdisplay of claim 23, wherein the planarizing spin on layer comprises a glass material.

25. The microdisplay of claim 23, wherein the planarizing spin on layer comprises Cyclotene.

26. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit; and
an electro-optic material between the conducting layer of the covering substrate and the base substrate, said electro-optic material having a pi oriented surface mode configuration for permitting the microdisplay to utilize a fast electro-optical effect.

27. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit; and
an electro-optic material between the conducting layer of the covering substrate and the base substrate, said electro-optic material having a sigma surface mode configuration for permitting the microdisplay to utilize a fast electro-optical effect.

28. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit; and
an electro-optic material between the conducting layer of the covering substrate and the base substrate, said electro-optic material having a folded surface mode configuration for permitting the microdisplay to utilize a fast electro-optical effect.

29. A microdisplay, comprising:
a base substrate having an actively addressable pixel array thereon;
a plurality of electrical contacts for connecting the pixel array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate, and
wherein said electrical input circuit comprises a digital backplane for applying discrete input values to pixels of said actively addressable pixel array multiple times per frame of generated images of said microdisplay, and
wherein voltages applied to said conducting layer of said covering substrate are selected in combination with said discrete input values applied to said pixels such that a voltage across said electro-optic material has a lower threshold value sufficient to maintain a retardation of not greater than λ/2.

30. A microdisplay, comprising:
a base substrate having an actively addressable pixel array thereon;
a plurality of electrical contacts for connecting the pixel array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate, and
wherein said external electrical input source comprises a digital backplane for applying discrete input values to pixels of said actively addressable pixel array multiple times per frame of generated images of said microdisplay, and
wherein voltages applied to said conducting layer of said covering substrate are selected in combination with said discrete input values applied to said pixels such that said voltages are inverted an even number of times per frame to average a net applied DC voltage to approximately zero.

31. The microdisplay of claim 30, wherein a bit number appearing an odd number of times per frame has alternating polarity from frame to frame for DC balancing said bit number to approximately zero over successive frames.

32. A microdisplay, comprising:
a base substrate having an actively addressable pixel array thereon;
a plurality of electrical contacts for connecting the pixel array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate, and
wherein said external electrical input source comprises a digital backplane for applying discrete input values to pixels of said actively addressable pixel array multiple times per frame of generated images of said microdisplay, and
wherein voltages applied to said conducting layer of said covering substrate are selected in combination with said discrete input values applied to said pixels such that said voltages are inverted an even number of times per frame to average a net applied DC voltage to approximately zero, and
wherein the electrical input circuit includes a storage node for storing inverted backplane voltages prior to application of said inverted voltages such that said stored voltages may be applied substantially simultaneously.

33. A microdisplay, comprising:
a base substrate having an actively addressable pixel array thereon;
a plurality of electrical contacts for connecting the pixel array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate, and
wherein said external electrical input source comprises a low voltage digital backplane for applying discrete input values to pixels of said actively addressable pixel array multiple times per frame of generated images of said microdisplay, and
wherein said electrical input circuit is formed on said base substrate.

34. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
a conductive trace connected to an additional electrical contact on a same surface as said plurality of electrical contacts, said additional electrical contact connected to said opposing electrical terminal;
a conductive crossover dot for connecting said conducting layer of said covering substrate to said conductive trace; and
an electro-optic material between the conducting layer of the covering substrate and the base substrate.

35. The microdisplay of claim 34, further comprising a perimeter seal for enclosing said electro-optic material between said base substrate and said covering substrate and having said conductive crossover dot disposed therethrough.

36. A microdisplay, comprising:
a stiffener;
a base substrate having an actively addressable array thereon, said base substrate being coupled to said stiffener for flattening said base substrate;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit; and
an electro-optic material between the conducting layer of the covering substrate and the base substrate.

37. The microdisplay of claim 36, wherein said base substrate comprises a silicon chip.

38. The microdisplay of claim 36, wherein said base substrate is adhesively coupled to said stiffener.

39. The microdisplay of claim 38, further comprising a UV cured adhesive adhesively coupling said base substrate and said stiffener.

40. The microdisplay of claim 39, wherein said stiffener comprises a substantially UV transmissive material for illuminating said adhesive with UV light through said stiffener.

41. The microdisplay of claim 40, wherein said stiffener comprises a ceramic material.

42. The microdisplay of claim 41, wherein said ceramic comprises an alumina ceramic.

43. The microdisplay of claim 42, wherein said alumina ceramic comprises alumina nitride.

44. A microdisplay, comprising:
a stiffener;
a base substrate having an actively addressable array thereon, said base substrate being coupled to said stiffener for flattening said base substrate;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate;
a perimeter seal for enclosing the electro-optic material between the covering substrate and the base substrate; and
a spacer array within the perimeter seal for setting a gap spacing between the covering substrate and the base substrate.

45. The microdisplay of claim 44, wherein the spacers comprise a thin film material.

46. The microdisplay of claim 44, wherein the spacers comprise a polymer material.

47. A microdisplay, comprising:
a stiffener;
a base substrate having an actively addressable pixel array thereon, said base substrate being coupled to said stiffener for flattening said base substrate;
a plurality of electrical contacts for connecting the pixel array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
a spacer array disposed at spaces between pixels of the pixel array for setting a gap spacing between the covering substrate and the base substrate.

48. The microdisplay of claim 47, wherein the spacers comprise a thin film material.

49. The microdisplay of claim 47, wherein the spacers comprise a polymer material.

50. A microdisplay, comprising:
a stiffener;
a base substrate having an actively addressable pixel array thereon, said base substrate being coupled to said stiffener for flattening said base substrate;
a plurality of electrical contacts for connecting the pixel array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
a spacer array disposed at spaces between pixels of the pixel array for setting a gap spacing between the covering substrate and the base substrate, wherein one or more pixels of the pixel array are cropped to enlarge one or more spaces between pixels of the pixel array such that one or more of said spacers may be larger than an original size of the one or more cropped spaces.

51. The microdisplay of claim 50, wherein the spacers comprise a thin film material.

52. The microdisplay of claim 50, wherein the spacers comprise a polymer material.

53. A microdisplay, comprising:
a stiffener;
a base substrate having an actively addressable array thereon, said base substrate being coupled to said stiffener for flattening said base substrate;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
a planarizing layer over the array of the base substrate.

54. A microdisplay, comprising:
a stiffener;
a base substrate having an actively addressable array thereon, said base substrate being coupled to said stiffener for flattening said base substrate;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit;
an electro-optic material between the conducting layer of the covering substrate and the base substrate; and
a planarizing spin on layer over the array of the base substrate.

55. The microdisplay of claim 54, wherein the planarizing spin on layer comprises a glass material.

56. The microdisplay of claim 54, wherein the planarizing spin on layer comprises Cyclotene.

57. A microdisplay, comprising:
a base substrate having an actively addressable array thereon;
a plurality of electrical contacts for connecting the array to an electrical input circuit;
a covering substrate over the base substrate, said covering substrate having a conducting layer thereon, said conducting layer being electrically coupled to an opposing electrical terminal to said electrical input circuit; and
an electro-optic material between the conducting layer of the covering substrate and the base substrate, and
wherein said plurality of electrical contacts include a plurality of pad areas, wherein at least some of said pad areas each include an area for making said contact with said electrical input circuit and an area for contacting a probe separate from said area for making said contact with said electrical input circuit.

58. The microdisplay of claim 57, wherein said area for making said contact with said electrical input circuit and said area for contacting said probe are connected by a conductive trace.

59. The microdisplay of claim 57, wherein said area for making said contact with said electrical input circuit and said area for contacting said probe are different portions of a same pad area having a geometry sufficient to accommodate each of said area for making said contact with said electrical input circuit and said area for contacting said probe, such that said area for making said contact with said electrical input circuit is not disturbed when said probe contacts said area for contacting said probe.
